(19) United States
(12) Patent Application Publication
(10) Pub. No.: US 2004/0093248 A1
(43) Pub. Date: May 13, 2004

(54) Method and apparatus for discovery, inventory, and assessment of critical information in an organization

(76) Inventor: Pratyush V. Moghe, Stow, MA (US)

Correspondence Address: PRATYUSH MOGHE, 80 ROBERT ROAD, STOW, MA, 01775, US

(21) Appl. No.: 10/691,865

(22) Filed: Oct. 24, 2003

Related U.S. Application Data
(60) Provisional application No. 60/420,817, filed on Oct. 25, 2002.

(51) Int. Cl. G06F 17/60

(52) U.S. Cl. 705/7

(57) ABSTRACT

Method and apparatus for discovery, inventory, and assessment of critical information in an organization, critical information including electronic data on computers, the method comprising the steps of defining critical information, distributing critical information policy to computers containing information that needs to be assessed, generating an inventory of information on each computer, assessing the criticality by applying the criticality definition, generating a report of assessment, collecting assessment reports from individual computers, and generating a reports for the organization at a computer and organization level, including a distribution of critical information and said apparatus comprising a centralized manager and distributed software components on computers containing information to be assessed.

### RELATED APPLICATIONS

This application is based on and claims priority and benefit of provisional U.S. patent application Ser. No. 60/420,817 filed Oct. 25, 2002.

### FIELD OF THE INVENTION

The present invention relates generally to security of critical information on computing devices, and more particularly, to an apparatus and method for discovery, inventory, and assessment of critical information in an organization.

### BACKGROUND OF THE INVENTION

As information grows rapidly, and with more and more of it distributed, and portable, it becomes important to be able to systematically and periodically assess the location and extent of critical information within an organization.

### Applications

Immediate applications of information assessment include:

Security: Critical information should be secured from security vulnerabilities, such as corruption, loss, or theft. Otherwise an organization may incur business and monetary damage. Information Assessment is the first step in securing critical information. Once critical information is tracked down, and its criticality is assessed, security CIO can then evaluate and fix security vulnerabilities.

Insurance: Even though information is an “intangible” property, its criticality to an organization can exceed tangible property assets. To help organizations insure themselves against the risk of information loss, Insurance companies may offer “information loss insurance”. Information Assessment forms a key early step in the insurance process.

Legal compliance: With the recent legal compliance requirements required by government regulations such as HIPPA, GLBA, Sarbanes-Oxley, etc. there is a new set of stringent requirements on data. Compliance with such standards require that organizations have knowledge of information that is distributed on their computers and further, have knowledge of what is critical and needs to be protected in accordance with these regulations.

### Challenges

It is not straightforward, however, to discover and assess the criticality of information and several challenges exist:

Definition of critical information: Defining critical information is the first step in being able to assess information criticality. Criticality depends on the organization, the context, and the content of data. For instance, critical information in a manufacturing organization is different from critical information in a financial firm. Similarly, information that is available on employee computers is more susceptible to loss that data stored only on central servers. Also, information is associated with privileges and should be associated with the appropriate level of employee. Finally, the actual content of a document makes it more or less critical than the other document. Hence, it is important to come up with a framework and methodology for defining critical information.

Locating distributed information: With the advent of mobile computing, remote workspaces, and traveling employees, it is challenging to be able to exactly determine what information is available on what computer and the owner of that information.

Assessment of information to determine if it is critical: Once criticality criteria are known and there is a mechanism to locate information, the last key challenge is in the ability to determine what part of that information is critical. This requires systematic techniques to scan information to determine if it is critical.

There are currently no known methods that can accomplish these three tasks.

### SUMMARY OF THE INVENTION

We describe an invention for Information Assessment, involving software that can define critical information and based on this definition, discover and evaluate critical information within an organization. The information itself can be on multiple distributed computing devices.

### BRIEF DESCRIPTION OF DRAWINGS

FIG. 1 illustrates the two components of the invention: IAA and IAM.

FIG. 2 illustrates the overall flowchart for the invention operation.

FIG. 3 illustrates the modules within the IAA.

FIG. 4 illustrates a sample embodiment of the invention where the IAM is implemented through a graphical user interface and is used for definition critical information tags

FIG. 5 illustrates a sample embodiment of the invention where the IAM displays the results collected by the IAA on a specific computer.

### DETAILED DESCRIPTION OF THE INVENTION

The Information Assessment invention is based on two unique concepts—

1. A framework to quantify the value of information by defining a metric called “criticality”. Criticality defines the importance of a particular information document. Two types of information signatures—tag signatures, which are attributes of the information document, and content signatures, which are content strings within the information document, determine the criticality of an information document.

2. A method to compute the criticality of any information document, based on signatures defined in 1. This method scans an information document, and searches for matches with a pre-defined set of signatures, and computes a criticality number for the document. Information criticality can then be summarized over an entire organization.

Next, we describe the details of the invention. We believe that these details are adequate for a practitioner, skilled in the art, to develop an information assessment apparatus.

### Prior Art

There is no current system that accomplishes the task of identifying critical information and using it to do an inventory of electronic data. There are many frameworks, which allow enterprise users to search for documents based on content patterns within documents. Common examples are enterprise-version search products such as Inktomi (www.inktomi.com), Google (www.google.com), AltaVista (www.Overture.com). However, we believe we are the first search-based inventory and classification system where a security-related criticality value is associated with each document.

From an inventory angle, a similar inventory product (such as www.mFormation.com) exists in the enterprise world that conducts the inventory of “applications” rather than documents. Such inventory products use different technology that searches the actual name of a running application within registry or MIBs to try and match it with the target application name.

### Invention Components

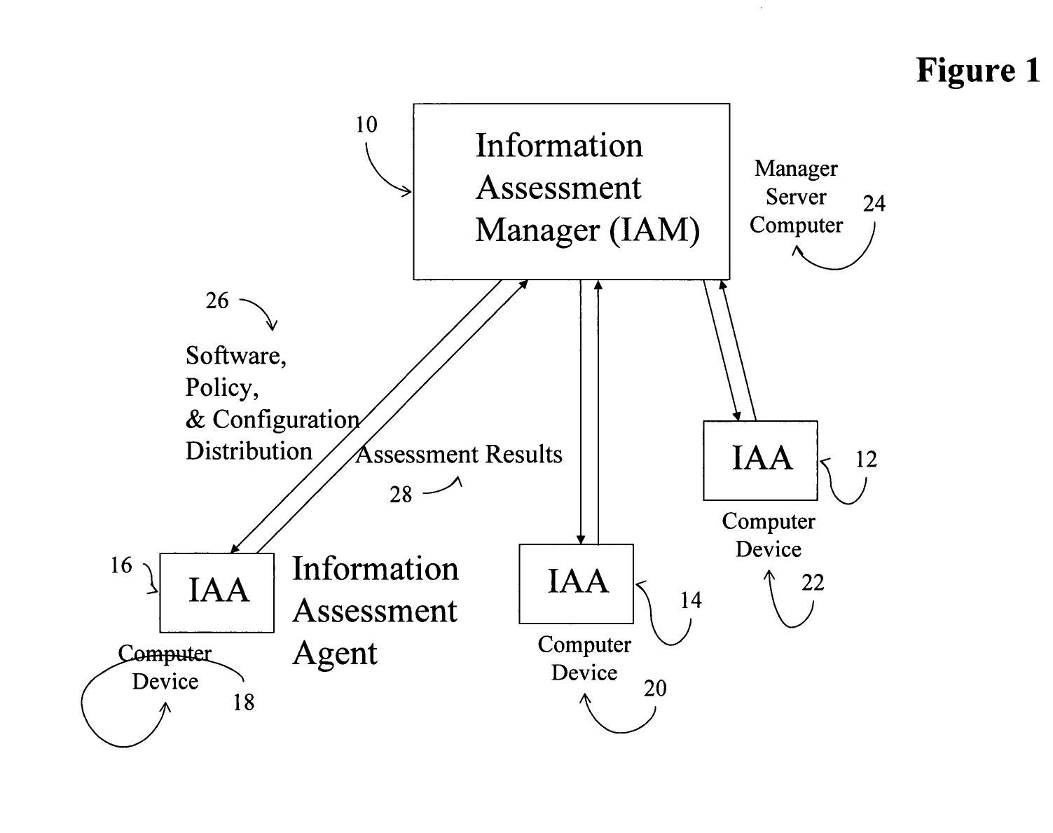

The information assessment invention comprises a Software Apparatus, indicated in FIG. 1.

In a preferred embodiment, the Apparatus consists of a centralized manager 10 (called Information Assessment Manager or IAM) running on a host computer or server 24, and distributed software 12, 14, 16 (called Information Assessment Agent or IAA) on each computer device 18, 20, 22 that stores information requiring assessment. Computer devices can be desktops, laptops, PDAs, servers, databases, with a variety of operating systems etc. The IAM and IAA communicate information 26, 28 over a network connection. The network can be any IP connection such as 10/100/1000 Mbs Ethernet or 802.11 wireless Ethernet or dial up modem.

### Invention Operation

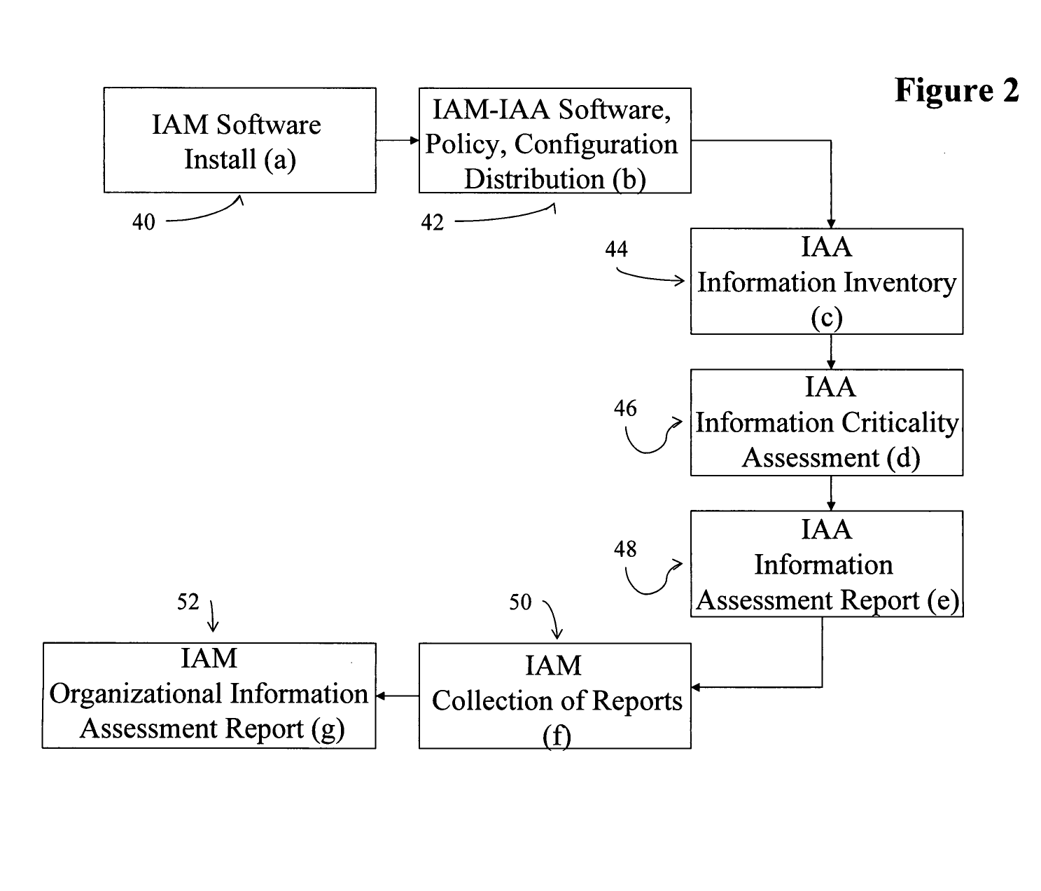

FIG. 2 shows the overall flow-chart of the invention operation. All modules executed by IAM are drawn horizontally, while modules executed by IAA are drawn vertically. Steps are:

a) The operation 40 begins with the IAM module being installed on a central server.

b) The IAM then distributes the IAA agent software 42 along with policy, and configuration information to the computer devices requiring assessment.

c) Each IAA first establishes Information Inventory 44.

d) Each IAA then executes Information Criticality Assessment 46.

e) Each IAA executes Information Assessment Reporting 48.

f) The IAM collects all the reports from different IAA systems 50.

g) The IAM computes organization-wide information assessment by summarizing and aggregating individual IAA reports 52.

### IAA Details

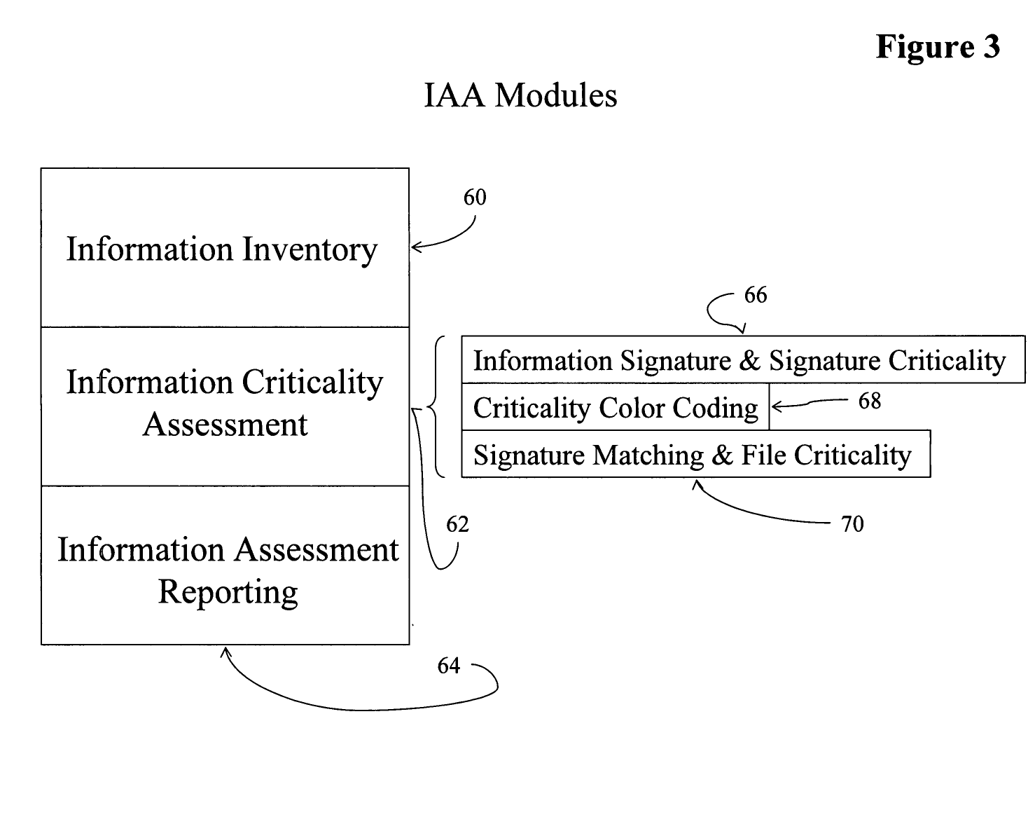

As described earlier, the IAA works on each system (device or media) and discovers and assesses information criticality. The IAA consists of three modules indicated in FIG. 3.

These include:

A. Information Inventory 60

B. Information Criticality Assessment 62

C. Information Assessment Reporting 64

This section describes the details of each module, including processes (algorithms, capabilities) and metrics.

A. AA: Information Inventory

A1: Information Inventory module 60 searches through all the files, folders resident on a system and summarizes the information found according to various categories:

1) Name of system—Internal DNS name

2) System Attributes—

a. Server, Desktop, Laptop

b. OS

c. MAC address

d. CPU-based id

3) Number of files and percentages of total number of files with certain suffix (.exe, .doc, .xls, .dll, .bin, .pdf, etc.)

4) Number of files and percentage of total number of files of a certain size (>1 MB, >10 MB, >100 MB, >1 GB)

5) Total amount of information (in GB)

A.2 Module creates for each system, a unique inventory ID. This ID is stored within the administrative database, and also on the system in an encrypted form.

B. IAA:Information Criticality Assessment

The Information Criticality Assessment module 62 assesses information in three sub-modules:

1) Information Signature & Signature Criticality 66—Creates two types of “signatures” as indicators of criticality

2) Criticality Color Coding 68—Associates each level of criticality with a color zone

3) Signature Matching & File Criticality 70—Scans information files, searches for matches with signature, computes file criticality.

We describe more details next.

B.1. Information Signature & Signature Criticality 66:

This sub-module defines the meaning of information criticality within an organization. It creates a set of information signatures, which are “strings” that are indicative of information criticality. The set of all signatures is called signature book.

Each information signature is associated with a signature ID and a criticality level between 0 and 10. Highest level of signature criticality is 10, while lowest is 0. To make them easy to use, the criticality level can be designated as low (L) or (0), medium (M) or (3), high (H) or (7), extreme (E) or (10).

Signatures can be of two types—

1. Tag Signatures

Tag signatures are attributes associated with information, which indicate how sensitive is the information.

An example set of tag signatures are:

| Sig ID | Tag | Signature Criticality |
|---|---|---|
| # | File extension (.dll) | M |
| # | File extension (.exe) | M |

¹Administrators can create signatures through a User Interface, which has not been specified in this document. The User Interface will allow them to create custom signatures, or delete default signatures

| | | |
|---|---|---|
| # | File password | H |
| | protection | |
| # | File encryption | E |

As seen above, tag signatures are attributes. For example, a file name with certain extension may indicate that it is critical for an organization. Alternatively, a file that is password-protected may indicate that it consists of highly critical information.

Other custom tag signatures can be defined by administrator, including file name, file author, other file extensions, file permissions, etc.

2. Content Signatures

Content signatures are strings “within” an information document that represent sensitive information. We define two types of content signatures—Generic, which are “organization-wide”, and Functional, which are “specific” to a particular functional group within the organization.

2a. Generic Signatures

An example set includes

| Signature ID | Signature | Signature Criticality |
|---|---|---|
| # | Top-Secret | E |
| # | Secret | E |
| # | Confidential | H |
| # | Proprietary | H |
| # | Restricted | H |
| # | Need-to-know | H |
| | Basis | |
| # | “organization- | H |
| | name” strategy | |
| # | “organization- | H |
| | name” plan | |
| # | Password | E |

Additional generic signatures can be custom added by the administrators.

2b. Functional Signatures

As described earlier, Functional signatures are “specific” to a particular functional group within the organization.

Administrators have to create functional signatures suitable for their organization. To aid them with this, the invention provides default functions (categories).

Within each function, the administrator can create a set of signatures that captures sensitive information for that function. For instance, within the

Technology function, the administrator of a pharmaceutical company can enter typical technical terms describing a new drug being discovered, or related to a recent patent etc.

Default functions include:

Technology
Product Management
Product Marketing
Sales
Business Development
Financial

Additionally, administrators may be allowed to create customized functions.

B.2 Criticality Color Coding 68:

To make visualization easy, each criticality level is assigned a color (or, interchangeably, called a zone).

Default colors are:

| Criticality Level | Color (Zone) |
|---|---|
| 10 | Red |
| 7 | Orange |
| 3 | Yellow |
| 0 | Green |

This sub-module can allow additional colors to support finer level of granularity.

B.3 Signature Matching & File Criticality Fc 70:

On each invocation, the sub-module searches to see if there is a signature match between the signature book and the information files on the system being surveyed.

A variety of commonly available OS-level or application-level Application Program Interfaces (APIs) can be used to determine for this. As an illustration, search for content signatures on Windows XP operating system could be implemented at the OS-level using the OS-level searching called Indexing Service. Alternatively, search can be implemented by a third-party programmatic application.

Because these APIs are obvious and dependent on each system, we will not specify actual APIS.

c1. File Criticality Fc

If the search yields a match between a particular signature and a file, the file is assigned a File Criticality level (Fc) equal to the Signature Criticality of the particular signature. If more than one signature is found in a file, the File Criticality is chosen as the maximum number between the Signature Criticalities of the matching signatures.

c2. Information Database

The sub-module creates an Information Database, where important properties are stored for each file. A row is created for each file discovered, and is then updated with the file name and criticality fields of the database. The database is stored within the system, and ultimately transported to the Information Assessment Manager. The following table illustrates the schema and one example row for the Information Database. Table 1 Information Database: Updates File Name and File Criticality

| Fully qualified | File Criticality | | |
|---|---|---|---|
| file name | (Fc) | Tag Signature | Content Signature |
| //hostid/path/file.doc | 10 | .exe | “Confidential” |

C. Information Assessment Reporting 64

This module defines metrics of criticality and issues an information assessment report.

C.1 System Criticality Metrics & Computation

d1. Table 1

f_count=Total number of information files on the system

| Criti- | File | Security | Number | |
|---|---|---|---|---|
| cality | Criti- | Desig- | of info | % of information in each |
| Zone | cality | nation | files | criticality zone |
| Red | 10 | E | f_red_{—} | f_red_count/f_count)*100 |
| | | | count | |
| Orange | 7 | H | f_orange_{—} | (f_orange_count/ |
| | | | count | f_count)*100 |
| Yellow | 3 | M | f_yellow_{—} | f_yellow_count/ |
| | | | count | f_count)*100 |
| Green | 0 | L | f_green_{—} | f_green_count/f_count)*100 |
| | | | count | |

d2. Criticality Report: System Criticality₂:

The sub-module defines a metric called System Criticality (S_criticality)², which represents the average criticality of information within the system (device).

S_criticality=Sum(criticality level×number of files at criticality level/f_count As an illustration, in the default example with 4 colors,

S_criticality=(10×f_red_count/f_count+7×f_orange_count/f_count+3×f_yellow_count/f_count+0×f_green_count/f_count)

System Criticality ranges from 0 and 10.

d3. Criticality Distribution:

Distribution of information in each criticality zone

The sub-module also defines criticality distribution, by plotting the histogram of percentages of files within each criticality zone.

Percentages have been computed in column 5 of the table above.

C.2 System Criticality Criteria

The sub-module computes three different criticality criteria, which can help summarize the criticality of the system. One or the other criteria may best suit a particular organizational environment.

e1. Absolutely Critical

System is absolutely critical if at least X information files lie in >=C1-color zone. X (integer), C1 (enum) are parameters, by default, X=1, C1=orange.

e2. Average Critical ²S_criticality represents how critical it is to ensure data security of the system being evaluated. Higher S_criticality implies higher mission criticality. If all the data on the system is within red zone, S_criticality would be close to 10, if all the data is within green zone, S_criticality would be near 0.

System is average critical if average system information criticality S_criticality >=Y. Y (double) is parameter, by default, Y=3.0.

e3. Percentile Critical

System is percentile critical if at least Z % of information files lie in >=C2 color zone. Z(double), C2 (enum) are parameters, set by default to Z=10, C2=orange.

e4. Table: Summary of How Information Critical is the System:

| Criticality Criterion | System Status |
|---|---|
| Absolutely Critical | Critical/NOT Critical |
| Average Critical | Critical/NOT Critical |
| Percentile Critical | Critical/NOT Critical |

### IAM Module

Policy Configuration and Distribution: The IAM is used to configure the criticality policies through a user interface. Once configured, the IAM allows the policies to be distributed to the IAA. This distribution can be configured to be on-demand or on a periodic schedule.

Organization Information Collection and Assessment Report: Once each IAA has completed issuing their individual system-level information assessment reports, these reports and the Information Database are sent back to the IAM module. The IAM module aggregates this information, and summarizes it at an organizational level.

f1: Table: Overall Information Assessment Summary

Date/Time:

| Systems Scanned | Number of Systems |
|---|---|
| System Categories | |
| Servers | |
| Desktops | |
| Laptops | |
| Media - Floppies | |
| Media - CDs | |
| Media - Tapes | |
| Databases | |

f2. Organization Information Criticality Report

| Criticality Criteria | Number of systems | % of total systems |
|---|---|---|
| Absolutely critical systems | Xabs | Pabs |
| Average critical systems | Xave | Pave |
| Percentile critical systems | Xper | Pper |

In the above table, the sub-module computes the number of systems that are critical by three definitions (Xabs, Xave, Xper), as well as the percentage of total systems that meet this criterion (Pabs, Pave, Pper).

The foregoing merely illustrates the principles of the present invention. Those skilled in the art will be able to device various modifications, which although not explicitly described or shown herein, embody the principles of the invention and are thus within its spirit and scope.

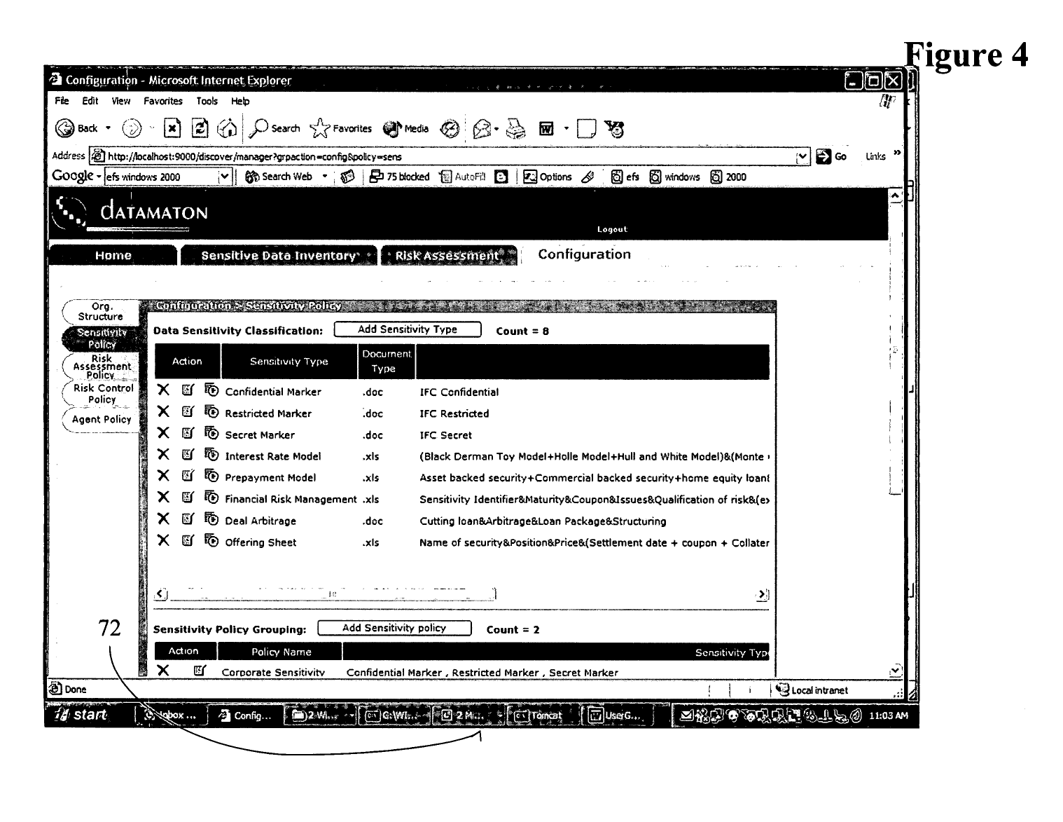

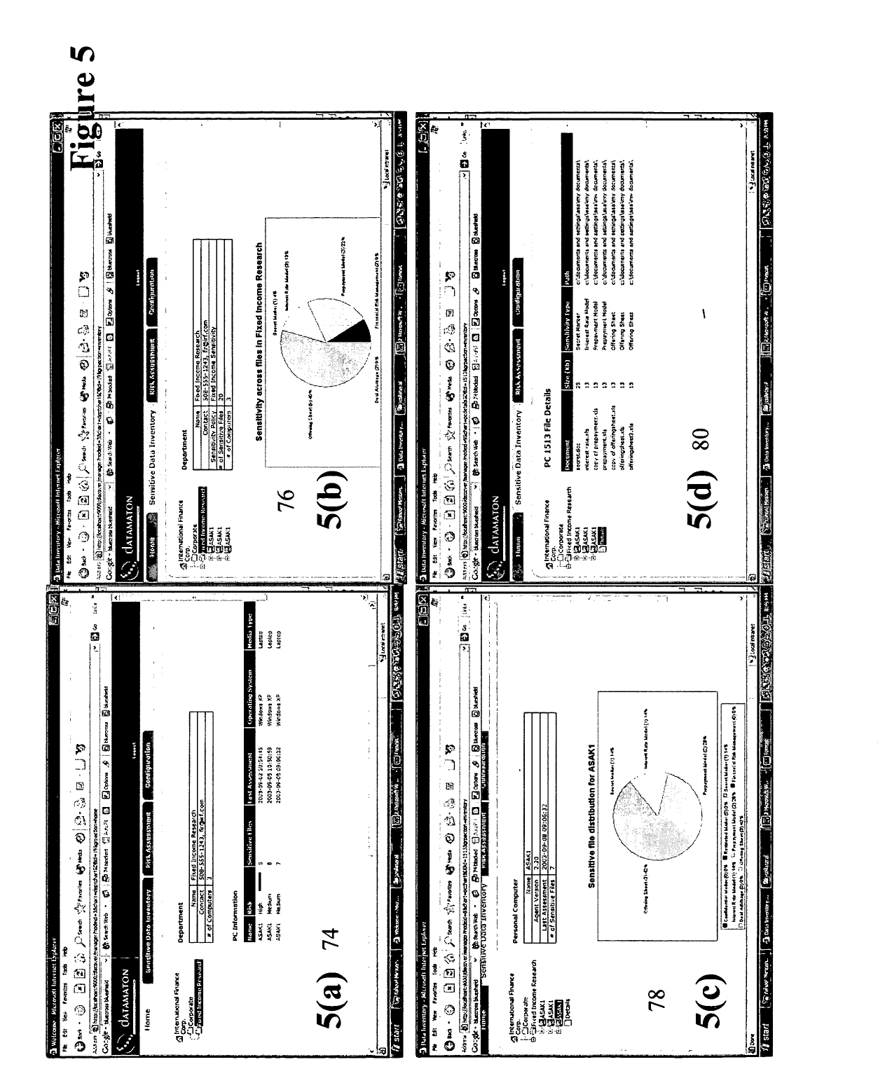

The above mentioned invention has been implemented in a specific embodiment. One instance of definition of criticality information 72 on the IAM is by means of a graphical user interface, as shown in FIG. 4. The IAA is implemented on user computers and generates results that are uploaded to the IAM. FIG. 5 shows one embodiment of the results when uploaded to the IAM and viewed by the graphical user interface on the IAM. FIG. 5(a) 74 shows the color coded organization level critical information, 5(b) 76 shows the distribution of critical information, 5(c) 78 shows the distribution of critical information at a computer level, and 5(d) 80 shows the details of critical information collected from a specific IAA.

What is claimed is:

1. Method for discovery, inventory, and assessment of critical information in an organization, said critical information including electronic data on computers, said method comprising the steps of:
a) defining critical information
b) generating a policy containing critical information definition
c) distributing this critical information policy to each computer that has critical information
d) generating the inventory of information on each computer
e) assessing the criticality of information based on the criticality definition in step c above
f) generating a report of the assessment results
g) collection of assessment results from all computers
h) generating a report of assessment results

2. A method, according to claim 1, where the critical information is defined by signatures.

3. A method, according to claim 2, where signatures include tag signatures and content signatures.

4. A method, according to claim 3, where tag signatures include markers on the data files, such as file type, password protection, encryption.

5. A method, according to claim 3, where content signatures include strings within an information document and include generic signatures as well as functional signatures.

6. A method, according to claim 5, where generic content signatures apply across the organization and functional content signatures apply to specific functional groupings.

7. A method, according to claim 1, where information inventory includes collecting information about the computing device, attributes of the computing device, a list of data files on the computing device, and attributes on the data file.

8. A method according to claim 7, where attributes on the data file include size, creation time, usage time, encryption information, password information.

9. A method, according to claim 1, where the critical information may be identified by color coding the criticality level.

10. A method according to claim 1, where assessment of critical information is done by identifying signature match between the signature book generated by definition of critical information and the signature of information documents on the computing device being assessed.

11. A method, according to claim 10, where the signature comparison could be accomplished by methods such as pattern matching, neural networks, weighted matches.

12. A method, according to claim 10, where signature matching could be accomplished using existing applications resident on the computing device.

13. A method, according to claim 12, where an instance of an existing application is the Indexing service popularly available on Microsoft windows operating system devices.

14. A method, according to claim 1, where generation of assessment reports includes creating a local database of storing information about each information document assessed.

15. A method, according to claim 14, where the assessment report includes average criticality and distribution of critical information.

16. A method, according to claim 1, where results from assessment of computing devices can be collected and correlated to generate aggregated criticality reports.

17. An apparatus for discovery, inventory, and assessment of critical information, said critical information including electronic data on computers, comprises:
a centralized software manager running on a computing device that is used to define critical information, distribute criticality definitions, collect assessment reports, and generate assessment results to determine critical information;
distributed software on each computing device that contains data to be assessed that is used to generate an inventory of information, assess critical information based on the criticality definition, generate a report of assessment, and send the results to the centralized software manager

18. An apparatus of claim 17, where the centralized software and distributed software communicate messages over a network

19. An apparatus according to claim 18, where the network could be an Ethernet, wireless, or dialup network and the messages may be encrypted.

20. An apparatus according to claim 17 where the criticality definition can be sent to the distributed software on a on-demand or periodic basis and where the results of assessment can be sent to the centralized manager on an on-demand or periodic basis.
